(19) United States
(12) Patent Application Publication
(10) Pub. No.: US 2019/0306927 A1
(43) Pub. Date: Oct. 3, 2019

(54) INDUCTION HEATING DEVICES AND CONTAINERS USABLE WITH INDUCTION HEATING DEVICES

(71) Applicant: James Heczko, Oceanside, CA (US)

(72) Inventor: James Heczko, Oceanside, CA (US)

(21) Appl. No.: 16/370,835

(22) Filed: Mar. 29, 2019

Related U.S. Application Data
(60) Provisional application No. 62/649,760, filed on Mar. 29, 2018.

(51) Int. Cl. H05B 6/06; H05B 6/12

(52) U.S. Cl. CPC H05B 6/062; H05B 6/1272

(57) ABSTRACT

A system for heating products including an inductive heating apparatus and a container for use with the inductive heating apparatus. The inductive heating apparatus includes a housing defining a channel for maintaining the container in an operative position. A helically wound induction coil is wrapped around a lower portion of the channel inductively heats a container maintained in the operative position within the chamber. A thermometer or temperature sensor measures the temperature of the container at a location above the induction coil. An electrically conductive element (or ring) positioned above the induction coil and beneath the thermometer improves the accuracy of the temperature reading from the thermometer relative to the actual temperature of the product in the container. The container includes a bottom and sidewalls enclosing a cavity, and products are contained within the cavity of the container. At least a portion of the container is susceptible to induction heating. The container includes one or more internal flow features (e.g., a lip, notch, groove, protrusion, indentation, slant, step, or paddle) that enhance mixing through eddy currents within the contents of the container when the container is heated, distributing heat within the product, and further increasing the accuracy of the reading at the apparatus' thermometer. The inductive heater apparatus may include a motor for mechanically transferring motion, such as rotation or gyration to a container. A paddle container for use with the motorized inductive heater apparatus includes one or more paddles in the container that function both as a flow feature and to efficiently transfer motion from the motor to the contents of the container, further improving mixing.

### CROSS-REFERENCE TO RELATED APPLICATIONS

This application relates to and claims the benefit of U.S. Provisional Application No. 62/649,760, filed Mar. 29, 2018 and entitled “Improvements to Induction Heating Devices and Containers Usable with Same,” the disclosures of which are incorporated herein by reference in their entireties. Additionally the entire disclosure of U.S. Pat. No. 9,967,924, titled “Package for storing consumable product, induction heating apparatus for heating package and system including same” and issued May 8, 2018 is incorporated herein by reference in its entirety. To the extent that any conflict or uncertainty may exist between the present specification and the disclosure of U.S. Pat. No. 9,967,924, the present specification shall control.

### BACKGROUND

### Technical Field

The present disclosure relates generally to induction heaters and containers used with induction heaters.

### Discussion of Related Art

Induction heating is frequently used to heat substances contained in induction-heatable vessels, notably in the preparation of hot foods and beverages in steel containers. A wide variety of systems and inventions have been developed for the convenient preparation of hot foods and beverages using induction heating. However, a problem persists in these systems. Specifically, it is difficult to measure the temperature of the contents of a container as that container is being subjected to induction heating. Such real-time measurement is important for precise temperature control and for safety.

In some situations, it is possible to measure the temperature of the contents of a container directly, by placing a thermometer or other temperature measurement device in direct contact with those contents (e.g., inserting a temperature probe into an open pot of soup). In other situations, however, it is impractical to apply a temperature measurement device directly to the contents. For example, it is often desirable to heat a consumable liquid while it remains hermetically sealed in a container such as coffee or soup in a steel can. In such cases, it would be desirable to obtain the temperature of the contents of a container by measuring the temperature of one or more parts of the container.

It has been observed in prior art that it is difficult to measure temperature of a liquid enclosed in a container as that container is being heated by induction. For example, in WO 2012/153394, the inventor notes that “ . . . since the can itself generates heat, the temperature of the surface of the can is a temperature higher than the contents.” The inventor of WO 2012/153394 describes a means of obtaining a more meaningful temperature measurement for the contents of the container by using the cap of a can rather than the body of a can as a temperature measurement surface.

WO 2012/153394 is limited in that it requires: 1) the container must be completely full so that the fluid in the container comes into contact with the cap, and it won't work for a partially filled container or a full container that has significant headspace; and 2) the container must be held at an angle during induction heating, and it might leak if the cap is not securely in place.

The current invention disclosure describes a means for measuring the temperature of a liquid in a container as that container is being heated. It is an improvement over WO 2012/153394 in that it allows for a partially filled container and/or a container that is not completely sealed. The present disclosure also describes additional factors (other than container heating by the induction field) that may distort temperature measurement, and the present disclosure describes devices and designs which remediate these factors.

### BRIEF SUMMARY

There exists a continuing need for an improved means for heating and measuring the temperature of a liquid or semi-liquid product sealed within a container. The current invention describes an induction heating apparatus and container with improved temperature measurement elements.

In an aspect of the present disclosure, an inductive heating apparatus includes a housing defining a channel for maintaining the container in an operative position. A helically wound induction coil wrapped around a lower portion of the channel inductively heats a container maintained in the operative position within the chamber. A thermometer or temperature sensor measures the temperature of the container at a location above the induction coil. An electrically conductive element (or ring) positioned above the induction coil and beneath the thermometer improves the accuracy of the temperature reading from the thermometer relative to the actual temperature of the product in the container.

In another aspect of the present disclosure, a container includes a bottom and sidewalls enclosing a cavity, and products are contained within the cavity of the container. At least a portion of the container is susceptible to induction heating. The container includes one or more internal flow features (e.g., a lip, notch, groove, protrusion, indentation, slant, step, or paddle) that enhance mixing through eddy currents within the contents of the container when the container is heated, distributing heat within the product, and further increasing the accuracy of the reading at the apparatus' thermometer. The flow feature may include a lip, a notch, a groove, a step, an indentation, a protrusion, a slant, a fin, or a paddle. The flow feature may be either a feature of the sidewall of the container or a separate feature either permanently bonded or removable from the inside of the container.

In a further aspect of the present disclosure, the inductive heater apparatus may include a motor for mechanically transferring motion, such as rotation or gyration to a container. A paddle container for use with the motorized inductive heater apparatus includes paddle in the container that function both as a flow feature and to efficiently transfer motion from the motor to the contents of the container.

An additional aspect includes the methods of manufacture and use of the induction heating apparatuses and containers described herein.

Each of these aspects and those disclosed herein may be combined in any way without limitation.

### BRIEF DESCRIPTION OF THE DRAWINGS

Objects and features of the presently-disclosed beverage packaging and heating system will become apparent to those of ordinary skill in the art when descriptions of various embodiments thereof are read with reference to the accompanying drawings, of which:

FIG. 1 is a perspective view of an existing container;

FIG. 2 is a perspective view of the container of FIG. 1 inserted into an existing induction apparatus;

FIG. 3 is a graph, in accordance with the prior art and various embodiments of the present disclosure;

FIG. 4 is a perspective view of a ring in position relative to a container, in accordance with an embodiment of the current disclosure;

FIG. 5 is a cross-sectional view of the container of FIG. 4 inserted into an induction apparatus, in accordance with an embodiment of the present disclosure;

FIG. 6 is a perspective view of a container with a notch, in accordance with an embodiment of the present disclosure;

FIG. 7 is a cross-sectional view of the container of FIG. 6 inserted into an induction apparatus, in accordance with an embodiment of the present disclosure;

FIG. 8 is a cross-sectional view of a container being subjected to induction heating, in accordance with an embodiment of the present disclosure;

FIG. 9 is a cross-sectional view of a container being subjected to induction heating, in accordance with the prior art;

FIG. 10 is a perspective view of an embodiment of a container that includes a groove along with another embodiment of a ring, in accordance with the present disclosure;

FIG. 11 is a cross-sectional view of the container of FIG. 10 inserted into an induction heating device, in accordance with the present disclosure;

FIG. 12 is a perspective view of an embodiment of a container that includes a step, in accordance with the present disclosure;

FIG. 13 is a cross-sectional view of the container of FIG. 12 inserted into an induction heating device, in accordance with the present disclosure;

FIG. 14 is a perspective view of an embodiment of a container that includes an indentation, in accordance with the present disclosure;

FIG. 15 is a cross-sectional view of the container of FIG. 14 inserted into an induction heating device, in accordance with the present disclosure;

FIG. 16 is a perspective view of an embodiment of a container that includes a protrusion, in accordance with the present disclosure;

FIG. 17 is a cross-sectional view of the container of FIG. 16 inserted into an induction heating device, in accordance with the present disclosure;

FIG. 18 is a perspective view of an embodiment of a container that includes a slant, in accordance with the present disclosure;

FIG. 19 is a cross-sectional view of the container of FIG. 18 inserted into an induction heating device, in accordance with the present disclosure;

FIG. 20 is a perspective view of an embodiment of a container with a generally square cross-section, in accordance with the present disclosure;

FIG. 21 is a perspective view of the container of FIG. 1 inserted into an induction heating device illustrating the position of ferrite blocks, in accordance with an embodiment of the present disclosure;

FIG. 22 is a perspective view of a three-piece can, in accordance with the prior art;

FIG. 23 is a cross-sectional view the container of FIG. 22 inserted into another embodiment of an induction device that includes multiple rings, in accordance with the present disclosure;

FIG. 24 is a perspective view of yet another container and a motor drive mechanism, in accordance with the present disclosure;

FIG. 25 is a cross-sectional view of the container of FIG. 24 inserted into an induction heating device which includes a motor drive, in accordance with the present disclosure;

FIG. 26 is a perspective view of an insert above a container, in accordance with an embodiment of the present disclosure;

FIG. 27 is a cross-sectional view of the insert of FIG. 26 placed in the container of FIG. 26 as it is inserted into an induction apparatus, in accordance with the present disclosure.

### DETAILED DESCRIPTION

Hereinafter, embodiments of a beverage packaging and heating system are described with reference to the accompanying drawings. Like reference numerals may refer to similar or identical elements throughout the description of the figures. The various features of the embodiments disclosed herein may be used alone, or in varying combinations with each other and are not intended to be limited to the specific combination described herein. Thus, the scope of the claims is not to be limited by the illustrated embodiments.

This description may use the phrases “in an embodiment,” “in embodiments,” “in some embodiments,” or “in other embodiments,” which may each refer to one or more of the same or different embodiments in accordance with the present disclosure.

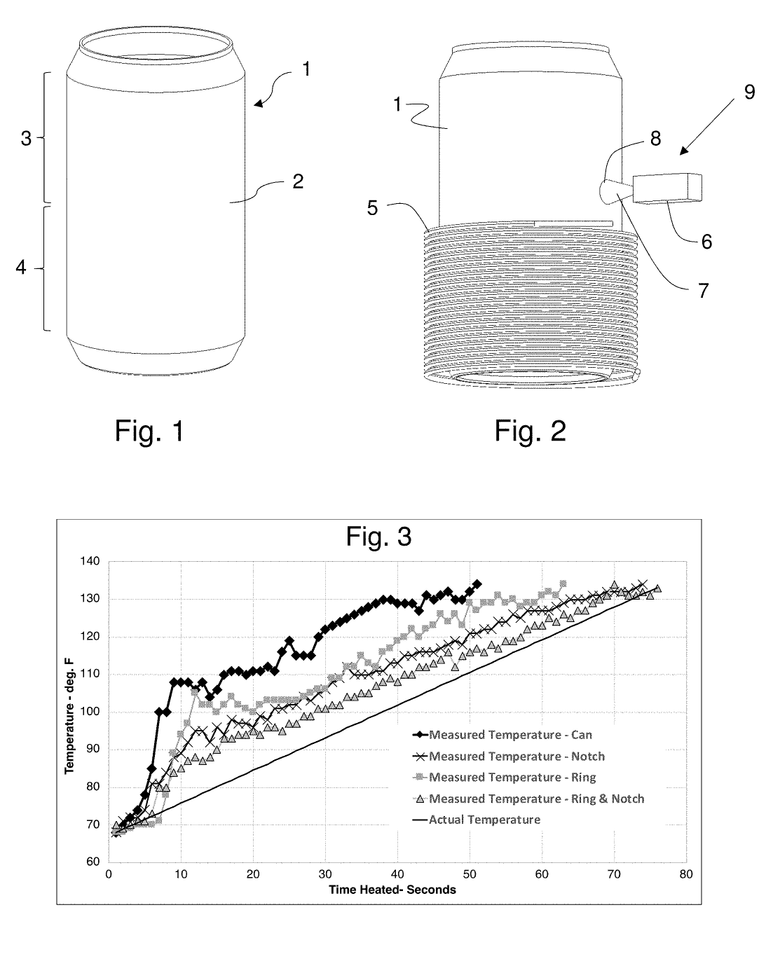

FIG. 1 illustrates a common steel can 1 in accordance with the prior art.

FIG. 2 illustrates an induction heating apparatus 9 used with can 1 in accordance with the prior art. Apparatus 9 comprises a helically wound induction coil 5 and thermometer 6. Coil 5 is connected to an electronic circuit (not shown) such that, when the circuit is activated, alternating current is produced in coil 5, creating an electromagnetic field which induces heat in can 1. Can 1 is inserted into a channel in apparatus 9 such that lower sidewall 4 is surrounded by the coil 5, while upper sidewall 3 is exposed. An infrared thermometer 6 measures temperature along a cone-shaped pattern 7. As a result, thermometer 6 measures the temperature of the exterior of can 1 at a read area 8, where pattern 7 intersects upper sidewall 3. As described herein, thermometer 6 is a non-contact infrared device. Nonetheless, it should be understood that a variety of temperature measurement devices may be employed in this situation, including without limitation a thermocouple or thermistor that makes physical contact with a container at a read area.

FIG. 3 is a chart which illustrates temperatures measured when using apparatus 9 (e.g., in FIG. 2) in various situations. For each of these situations, a container is filled with a constant mass of liquid 11 at a consistent starting temperature of 67 degrees F., from case to case. The container is heated using constant power (e.g., 1000 watts) applied to the container using induction heating apparatus 9, and the temperature is measured at a read area 8 throughout the heating process. FIG. 3 shows a solid line with no markers entitled “Actual Temperature”. This line is used as a reference for various test runs using apparatus 9. “Actual Temperature” represents the average temperature of liquid 11 at a given point of time based on a computation. Such computation incorporates the starting temperature of liquid 11 and container, the mass of liquid 11 and container, the heat capacity of liquid 11 and container, the power applied to the system, and the cumulative time that power is applied. In each of the tests, the results of which are illustrated in FIG. 3, liquid 11 is water.

FIG. 3 illustrates the problem of temperature measurement in the prior art. A line with diamond-shaped markers is entitled “Measured Temperature—Can”. This series of temperature measurements is derived from the configuration illustrated in FIG. 2, in which the prior art of can 1 is heated in apparatus 9. As you may see from the chart, the temperature measured at read area 8 increases rapidly in the first ten seconds of heating, from 67 degrees F. to approximately 110 degrees F. In contrast, as the Actual Temperature line indicates, the actual average temperature of can 1 and the liquid 11 after 10 seconds is approximately 73 degrees, and there is a measured temperature difference of approximately 47 degrees. A comparable temperature difference persists throughout the heating process, thought the degree of difference varies.

Thus, the container and apparatus of the prior art do not lend themselves to reliably measuring the temperature of the contents of the can 1, and the temperature measured is not particularly useful for controlling the heating process of an induction heater.

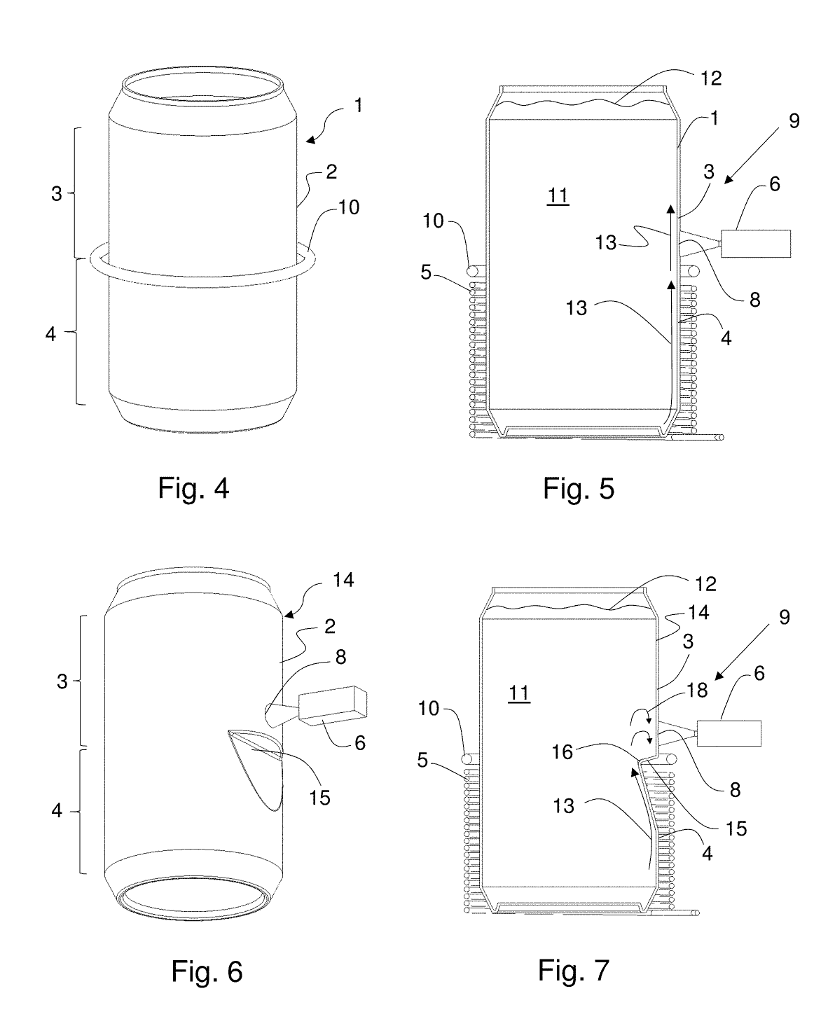

FIGS. 4 and 5 show one aspect of the current invention, wherein an electrically conductive element or ring 10 is included in the induction heating apparatus. FIG. 4 is a perspective view showing the relative positions of can 1 and ring 10. FIG. 5 is a cross-sectional view of can 1 inserted into coil 10, with the ring positioned immediately above coil 10. Can 1 is filled with liquid 11 up to fill level 12. Thermometer 6 is positioned to measure the temperature of can 1 at read area 8. Read area 8 is located on upper sidewall 3 above ring 10. Ring 10 is made from an electrically conductive material such as copper or aluminum. Ring 10 is positioned around can 1, above and adjacent to coil 5, near and parallel to the plane separating upper sidewall 3 and lower sidewall 4. Ring 10 has an inner diameter approximately matching that of coil 5, though it may be moderately larger or smaller. In applying the ring concept to various induction heating systems, a ring 10 may be made part of an induction heating appliance, attached to a can or other container 1, or applied as a separate element of the system.

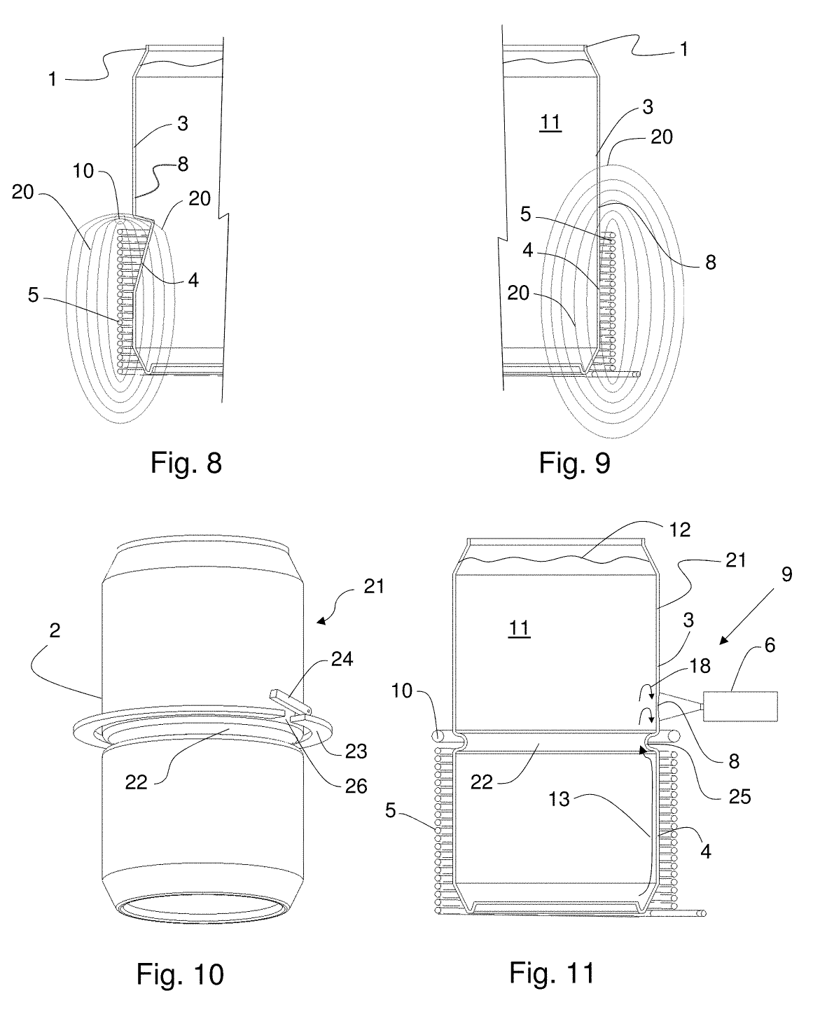

FIGS. 8 and 9 illustrate a model of induction heating which explains the effect of ring 10 on induction heating and the results illustrated in the temperature graphs of FIG. 3. According to this model, and referring to FIG. 9, when high frequency alternating current is applied to coil 5, an electromagnetic field is created. The extent of the field is shown by field lines 20. The electromagnetic field produced by coil 5 induces current in conductive objects located within that field. When alternating current is applied to coil 5, coil 5 electromagnetically couples with can 1; electric current is induced in can 1 along the portions of can 1 where field lines 20 intersect can 1; and the induced current heats can 1 along those portions. As shown in FIG. 9, the electromagnetic field encompasses and heats all of lower wall 4 (e.g., the lower portion of the sidewall). In addition, a portion of the electromagnetic field extends above the top of coil 5 such that the field heats a portion of upper wall 3 (e.g., the upper portion of the sidewall) including read area 8. Because the surface of the sidewall is being actively heated, the temperature of upper wall 3 rises, and a temperature measured at read area 8 tends to be higher than the temperature of liquid 11 located adjacent to read area 8.

The construction of each aspect or embodiment of the present disclosure shall not be limited in any way if any description or figure imprecisely or incorrectly depicts either theoretical models or experimental results disclosed in this application. The aspects and embodiments disclosed are sufficient to properly convey the claimed combination of features and elements, regardless of potential future discovery or improved understanding of the exact forces and/or fields responsible for these behaviors.

FIG. 8 illustrates how the presence of the ring 10 may modify the shape of the electromagnetic field produced by coil 5. Ring 10 is made of an electrically conductive material, preferably a material with low susceptibility to induction heating and high electrical conductivity, such as copper or aluminum. With ring 10 placed above coil 5, and when alternating current is introduced into coil 5, coil 5 electromagnetically couples with both ring 10 and with can 1. As coil 5 couples with ring 10, the shape of the electromagnetic field shifts, and the electromagnetic field no longer extends above ring 10. This is shown by field lines 20 in FIG. 8. As a result of this field shift, coil 5 does not directly heat upper sidewall 3 or read area 8. Consequently, the temperature of read area 8 is not significantly influenced by the magnetic field and tends to represent the temperature of liquid 11 that is located within can 1 adjacent to read area 8.

Laboratory test runs support the theoretical model as described. As FIG. 3 indicate, temperatures measured at read area 8 are lower when ring 10 is present, suggesting that there is not as much active heating of read area 8 by coil 5. In addition, it was observed that the copper ring 10 used in the experiments tended to warm-up during the heating cycle, even though the ring 10 did not come into contact with the can 1. This suggests that current was being induced in the copper ring 10.

Note that a ring 10 only has this effect on an induction system if the ring 10 is continuous. A broken or split ring 23 (see, e.g., FIG. 10) does not result in the same effect; a discontinuous copper ring does not warm-up in the induction device and the presence of such a discontinuous ring does not materially influence measured temperatures. This leads to another aspect of the current invention: the ring 23 may include a switch 24 which breaks the continuity of the ring 23. When the switch 24 is “off” (i.e., the ring 23 is broken or discontinuous), then the field produced by the coil 5 will extend beyond the coil 5, as if the ring 23 is not present. When the switch 24 is “on” (i.e., the ring 23 is continuous), then the ring 23 reduces the extent of the field, as described above. Thus, a switch 24 in the ring 23 provides a means of variably altering or shaping the field produced by the coil 5, which could be useful for optimizing a heating cycle or for heating different shaped containers. An example of this in accordance with the present disclosure is illustrated in FIG. 10. In this case, ring 23 is broken by gap 26. A switch 24 may be open (as shown) to create a discontinuity in ring 23. Alternately, switch 24 may be closed (not shown) to form a continuous electrical path through ring 23. FIG. 10 shows a physical switch on ring 23. Nonetheless, it should be appreciated that a switch used for this purpose may take many forms, including for example an electric relay or a semiconductor device that acts as a switch.

FIG. 10 illustrates another aspect of the invention. Specifically, ring 23 has a rectangular cross-section rather than the circular cross-section illustrated in other embodiments of the invention. It should be understood that the electrically conductive element (e.g., ring 10) in the current disclosure may be formed with a variety of cross-sections not explicitly described herein. In addition, while the embodiments herein generally describe a round ring 10 that surrounds a round container (e.g., a can 1), the ring 10 does not necessarily need to be round to effectively alter the electro-magnetic field and have the positive effects on an induction system that are described in the present disclosure. For example, the ring 10 may be ovoid, generally square or a wide variety of other shapes so long as the ring 10 is continuous, and at least a portion of the ring 10 is located adjacent to a portion of the induction coil 5 (e.g., the portion of the induction coil adjacent to a thermometer read area 8). The ring 10 of the current invention may be a distinct element of an induction system, or it may be part of or integral to another part of the induction device or the container. For example, an induction heating appliance may have an aluminum enclosure, a portion of which lies adjacent to the induction coil. Such an enclosure could effectively act as the conductive ring described in the present disclosure. Similarly, the lip of the channel may include an electrically conductive element, enhancing durability and/or aesthetics while also acting as the conductive ring described above.

The use of one or more rings in an induction heater may have advantages other than the improvement in temperature measurement described above. For example, one or more rings may be used to avoid overheating of can seams 56/58 during thermal processing of canned foods. FIG. 22 illustrates a three-piece can 54 in accordance with the prior art. Can 54 includes an upper end 55 which is seamed onto a can body 50 along upper seam 56. Can 54 also includes a lower end 57 (shown in FIG. 23) seamed onto a can body 50 along lower seam 58. A food or beverage producer may use a container such as can 54 to store a prepared food such as soup. Further, a producer may wish to thermally process a prepared food in a container such as can 54 using induction heating. In such a situation, a problem has arisen in that the seams 56/58 of a can 54 become overheated when the can 54 is heated by an induction field. The seam(s) 56/58 of a can 54 include(s) several layers of metal, each of which may be heated by an induction field. Further, unlike the body of a can 54, the seam 56/58 is not in direct contact with the liquid inside the can 54. Thus, when an induction field is applied to a can seam 56/58, the seam 56/58 heats up quickly due to multiple metal layers, and the heat is not abated by direct contact with a liquid. Consequently, the temperature of a seam 56/58 rises much more quickly than the temperature of a can body 50. And such elevated temperature may result in a burning or other failure of the seam 56/58.

FIG. 23 illustrates a configuration of an induction heater according to the current disclosure which may be used to thermally process a can of foodstuffs without the problem of overheated seams. Standard can 54 is positioned within coil 5. An upper ring 59 separates the top of coil 5 from upper seam 56. A lower ring 60 separates the bottom of coil 5 from lower seam 58. When alternating current is applied to coil 5, an electromagnetic field emerges which couples with and heats can body 50. However, due to the presence of upper ring 59 and lower ring 60, the electromagnetic field reaching upper seam 56 and lower seam 58 is reduced or eliminated, and these seams do not overheat.

FIG. 21 illustrates an alternate embodiment of the current disclosure. In this case there is a standard can 1, an induction coil 5 and a ring 10. In addition, one or more ferrite blocks 53 are located between coil 5 and ring 10. As noted above in the discussion regarding FIGS. 8 and 9 and the theory behind using a ring, ring 10 may heat up when alternating current is applied to coil 5. It has been found through experimentation that it can be advantageous to place one or more pieces of ferrite 53 between coil 5 and ring 10, as shown in FIG. 21. Specifically, when one or more pieces of ferrite 53 is present between the coil and the ring, the temperature of the ring 10 does not rise as much as when there is a ring 10 alone. And the ring 10/ferrite 53 combination limits the field of the coil 5 as much as when using the ring alone. Note that, unlike the ring 10, the ferrite or ferrites 53 need not form a continuous loop adjacent to the coil 5; multiple separate segments of ferrite block 53 are effective, as is a single ring-shaped piece of ferrite 53.

FIGS. 6 and 7 show an alternate embodiment of an induction-heatable container 14 in accordance with the present disclosure. In the embodiment illustrated in FIG. 6, a notch 15 is formed in the sidewall 2 of notched container 14. A portion of upper sidewall 3 located above notch 15 is a read area 8 for thermometer 6.

In FIG. 7, notched can 14 has been inserted into apparatus 9 so that lower sidewall 4 is surrounded by coil 5 and read area 8 is positioned adjacent to thermometer 6. Notch 15 includes lip 16, located on the upper side of notch 15, near the plane dividing upper sidewall 3 and lower sidewall 4. Lip 16 extends generally radially inward toward the axial center of the notched can 14. A ring 10 is positioned above and near coil 5, generally parallel to the plane between upper sidewall 3 and lower sidewall 4.

FIG. 3 is a chart which illustrates and discloses how a notch present on a container can improve temperature measurement in an induction heating system. Specifically, the chart in FIG. 3 shows a line entitled “Measured Temperature—Ring & Notch” and marked with triangles. This line represents temperature measurements taken using apparatus 9, with ring 10 and notched can 14 illustrated in FIG. 7. As FIG. 3 shows, Measured Temperature—Ring & Notch more closely matches the Actual Temperature than does Measured Temperature Ring, indicating that the presence of notch 15 has a positive effect on the accurate temperature measurement of this induction system. Another line on FIG. 3 is entitled “Measured Temperature—Notch,” and marked with X's. This line represents the temperature measured using notched can 14 in apparatus 9 in FIG. 6, with ring 10 removed (this embodiment is not illustrated in the drawings provided but should be readily understandable in light of the various included drawings). As this line suggests, the presence of notch 15 on notched can 14 improves temperature measurement accuracy of the system relative to a straight-walled can (i.e., can in FIGS. 1 and 2). Further, it should be clear from FIG. 3 that notch (or flow feature) 15 and ring 10 cooperate to produce more meaningful temperature measurements than each element produces individually.

FIGS. 5 and 7 illustrate a theoretical model that is part of the current disclosure as to why the presence of notch 15 on notched can 14 results in improved temperature measurement relative to straight-walled can 1. According to this model, and referring to FIG. 5, which illustrates a straight-walled can 1 undergoing induction heating, when current is applied to induction coil 5, lower sidewall 4 heats rapidly. As a result, liquid 11 located adjacent to lower sidewall 4 becomes super-heated. For the purpose herein, “super-heated” refers to a condition wherein the liquid is significantly hotter than the average temperature of liquid elsewhere in the container. Super-heated liquid 13 is less dense than the other liquid in the container. Consequently, super-heated liquid 13 rises within can 1, passing from lower sidewall 4 to upper sidewall 3. As super-heated liquid 13 flows past upper sidewall 3, it heats upper sidewall 3, including read area 8, to a temperature that is significantly higher than the average temperature of liquid 11. As a result, the temperature which thermometer 6 measures at read area 8 is significantly higher than the average temperature of liquid 11.

Referring now to FIG. 7 which illustrates notched can 14 undergoing induction heating. When current is applied to coil 5, lower sidewall 4 heats rapidly. Super-heated liquid 13 is created and rises along lower sidewall 4 until super-heated liquid 13 flows past lip 16. At lip 16, the convective flow of super-heated liquid is disrupted, creating turbulence and eddies 18. Eddies 18 mix super-heated liquid 13 together with cooler liquid present in notched can 14. As a result, the liquid 11 which swirls past read area 8 is a mixture of cool and hot liquid. Such mixture has a temperature that is cooler than super-heated liquid 13 and is more representative of the average temperature of liquid 11. Thus, the temperature which thermometer 6 measures at read area 8 is more indicative of the average temperature of liquid 11 for the notched can 14 illustrated in FIG. 7 than it is for the straight-walled can 1 of the prior art illustrated in FIG. 5.

FIGS. 10 and 11 show an alternate embodiment of an induction-heatable container in accordance with the present disclosure. In this embodiment, a grooved can 21 includes a radial groove 25 formed in sidewall 2 of grooved can 21. As shown in FIG. 11, when grooved can 21 is inserted into apparatus 9, groove 25 is near the top of coil 5, and read area 8 is located above groove 25.

Grooved can 21 illustrated in FIG. 11 functions in a similar manner to notched can 14 illustrated in FIG. 5. When grooved can 21 is subjected to induction heating in apparatus 9, the temperature measurements taken from thermometer 6 follow a pattern similar to those illustrated in FIG. 3 for notched can 14. Experimental results indicate that when the grooved can 21 is subjected to induction heating, grooved can 21 behaves in a comparable manner to that which was described for notched can 14. Specifically, coil 5 heats lower sidewall 4, creating super-heated liquid 13 which flows upward within grooved can 21. When super-heated liquid 13 passes lip 25, the convective flow of super-heated liquid is disrupted creating eddies 18. Eddies 18 mix super-heated liquid 13 with cooler liquid, and the result is a temperature measured at read area 8 that is more representative of the average temperature of liquid 11 in grooved can 21.

Grooved can 21 demonstrates a distinctive and potentially useful feature compared to notched can 14 in that grooved can 21 may be rotated at any angle within coil 5 and retain its improved temperature measurement attributes. Observe from FIG. 5 that read area 8 of notched can 14 is located specifically above notch 15. Thus, to be effective, notch can 14 must be inserted in coil 5 such that the area immediately above notch 15 is aligned with thermometer 6. In contrast, grooved can 21 is radially symmetrical, and read area 8 can be anywhere along the circumference of grooved can 21 above groove 25. So, when grooved can 25 is inserted into coil 5 of apparatus 9, a portion of groove 25 is always located beneath thermometer 6, regardless of the rotational position of grooved can 21 within the coil 5.

Note that many steel cans in the prior art feature a series of corrugations or beads used for strengthening the sidewall of the can. An example of a beaded can of the prior art is illustrated in FIG. 22. Can 54 includes a series of beads 61 which reinforce can body 50 against radial loads. In steel cans of the prior art, beads are generally less than 1 mm deep on a 54 to 70 mm diameter can. While such beads strengthen the can against radial loads, deep beads tend to weaken a can against axial loads. Further, deep beads are more difficult to form than shallow beads.

In tests run with a beaded can of the prior art with multiple beads less than 1 mm deep, there was no appreciable improvement in temperature measurement (i.e., the test results were similar to those described in FIG. 3 for “Measured Temperature—Can”). In the embodiment illustrated in FIG. 11, the depth of groove 22 on grooved can 21 is approximately 4 mm; test results for this 4 mm bead were comparable to those illustrated in FIG. 3 for “Measured Temperature—Notch”. In other tests, a grooved can with a 2.5 mm deep groove was used, and these tests indicated a measurable improvement in temperature measurement efficacy relative to a straight walled can, though not as much improvement as that experienced with the can with a groove depth of 4 mm. Thus, it appears that meaningful improvement in temperature measurement occurs when a groove depth is greater than 1 to 2.5 mm.

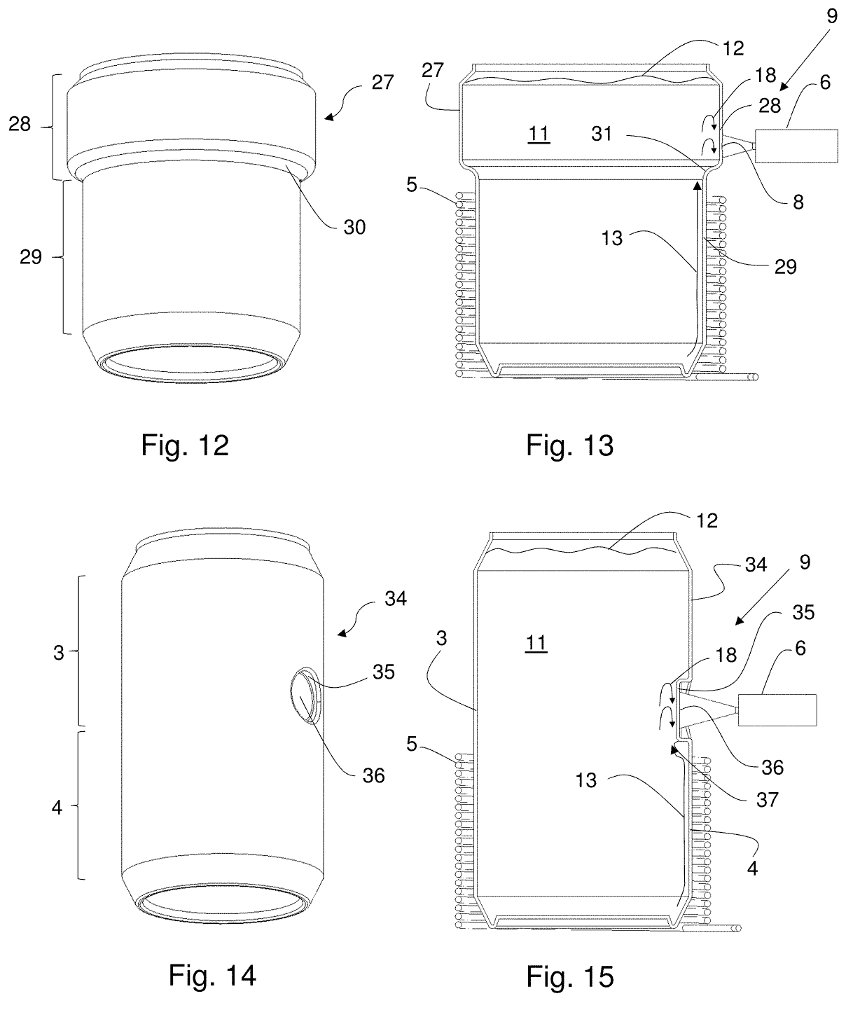

FIGS. 12 and 13 illustrate another embodiment in accordance with the current disclosure. In this embodiment, a stepped can 27 has an upper sidewall 28 that has a larger diameter than its lower sidewall 29. The differing diameters create step 30 at the intersection of upper sidewall 28 and lower sidewall 29. Step 30 includes lip 31, where lower sidewall transitions into step 30. Stepped can 27 functions in a similar manner to notched can 14 illustrated in FIG. 5. When stepped can 27 is subjected to induction heating in apparatus 9, the temperature measurements taken from thermometer 6 follow a pattern similar to those illustrated in FIG. 3 for notched can 14. Experimental results indicate that when stepped can 27 is subjected to induction heating, stepped can 27 behaves in a comparable manner to that which was described for notched can 14. Specifically, coil 5 heats lower sidewall 29, creating super-heated liquid 13 which flows upward within stepped can 27. When super-heated liquid 13 passes lip 31, the convective flow of super-heated liquid is disrupted creating eddies 18. Eddies 18 mix super-heated liquid 13 with cooler liquid, and the result is a temperature measured at read area 8 that is more representative of the average temperature of liquid 11 in stepped can 27. In tests of stepped cans with various step sizes, measurable improvement in temperature measurement accuracy has been be achieved with step sizes as low as 2 or 3 mm (i.e., stepped cans with an upper sidewall that is 4 or 6 mm greater in diameter than the lower sidewall). Like grooved can 21 illustrated in FIG. 11, stepped can 27 is radially symmetrical, allowing it to function at any rotational position within coil 5.

FIGS. 14 and 15 illustrate another embodiment in accordance with the current disclosure. In this embodiment, indented can 34 has an indentation 35 protruding generally radially inward from upper sidewall 3 of the container 34. A read area 36 is located within indentation 35. Indentation 35 creates a lip 36. Experimental results indicate that when indented can 34 is subjected to induction heating, indented can 34 behaves in a comparable manner to that which was described for notched can 14. Specifically, coil 5 heats lower sidewall 4, creating super-heated liquid 13 which flows upward within indented can 34. When super-heated liquid 13 passes lip 37, the convective flow of super-heated liquid is disrupted creating eddies 18. Eddies 18 mix super-heated liquid 13 with cooler liquid, and the result is a temperature measured at read area 36 that is more representative of the average temperature of liquid 11 in indented can 34.

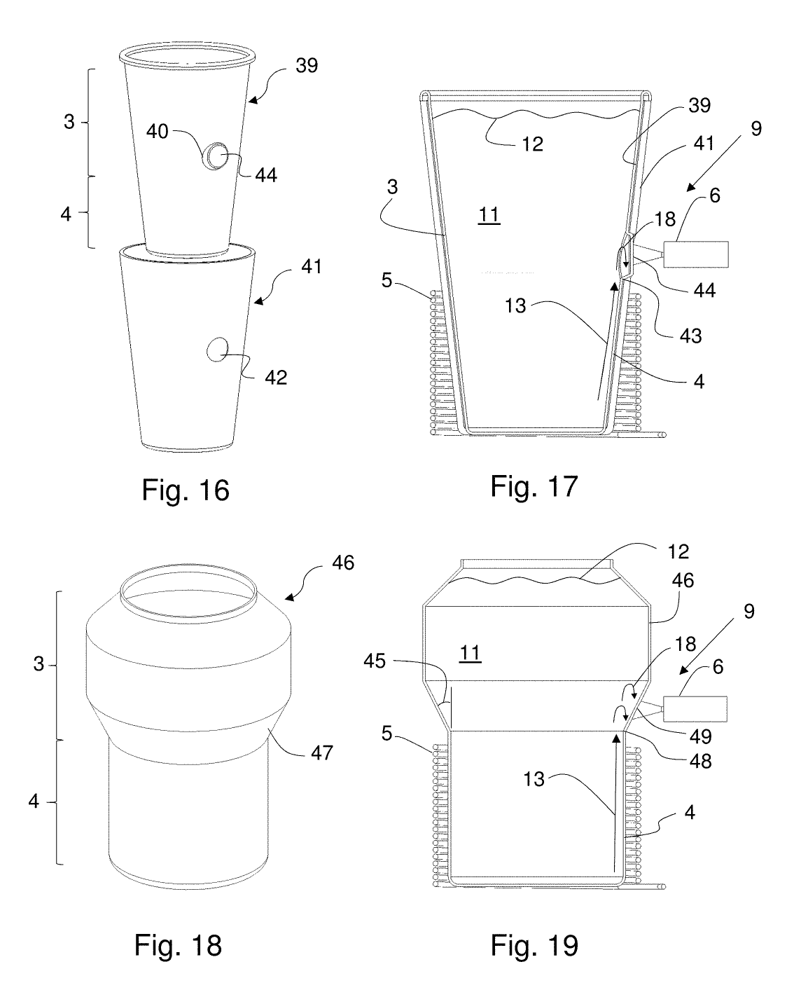

FIGS. 16 and 17 illustrate another embodiment in accordance with the current disclosure. In this embodiment, protrusion container 39 includes protrusion 40 protruding generally radially outward from upper sidewall 3 of the container 39. A read area 44 is located on protrusion 40. Protrusion 40 creates a lip 43. Experimental results indicate that when protrusion container 39 is subjected to induction heating, protrusion container 39 behaves in a comparable manner to that which was described for notched can 14. Specifically, coil 5 heats lower sidewall 4, creating super-heated liquid 13 which flows upward within protrusion container 34. When super-heated liquid 13 passes lip 43, the convective flow of super-heated liquid is disrupted creating eddies 18. Eddies 18 mix super-heated liquid 13 with cooler liquid, and the result is a temperature measured at read area 44 that is more representative of the average temperature of liquid 11 in protrusion container 39.

Protrusion container 16 illustrates some additional aspects of the present invention and disclosure. While several of the embodiments described in this disclosure resemble a steel can, the operating principles disclosed herein are applicable to a variety of containers. For example, containers of the present disclosure need not have straight sidewalls, as FIG. 16 illustrates for protrusion container 38. In this case, upper sidewall 3 and lower sidewall 4 are tapered rather than straight. The structures (notches, steps, etc.) and principles (disrupting superheated liquid flow) described herein can be applied to a variety of container shapes, including those with straight walls, tapered walls, contoured walls, etc. Containers of the present invention may be reusable and/or fabricated from materials other than steel, such as stainless steel, clad, plated or laminated metals. Although not typically used with household inductive heating systems, other materials including brass, aluminum, copper, carbon, graphite, and silicon carbide have been demonstrated to experience some heat from inductive heating devices and may be used in some specific configurations within the scope of the present invention. The only requirement is that at least a portion of the container is susceptible to induction heating.

Containers described in this disclosure may be combined with additional elements to improve their usability. For example, and as illustrated In FIGS. 16 and 17, a container may be fitted with an insulating sleeve 41, which makes a hot container more comfortable and/or safe for a user to handle. In such a case, insulating sleeve 41 may include an insulation gap 42 which facilitates temperature measurement at read area 44.

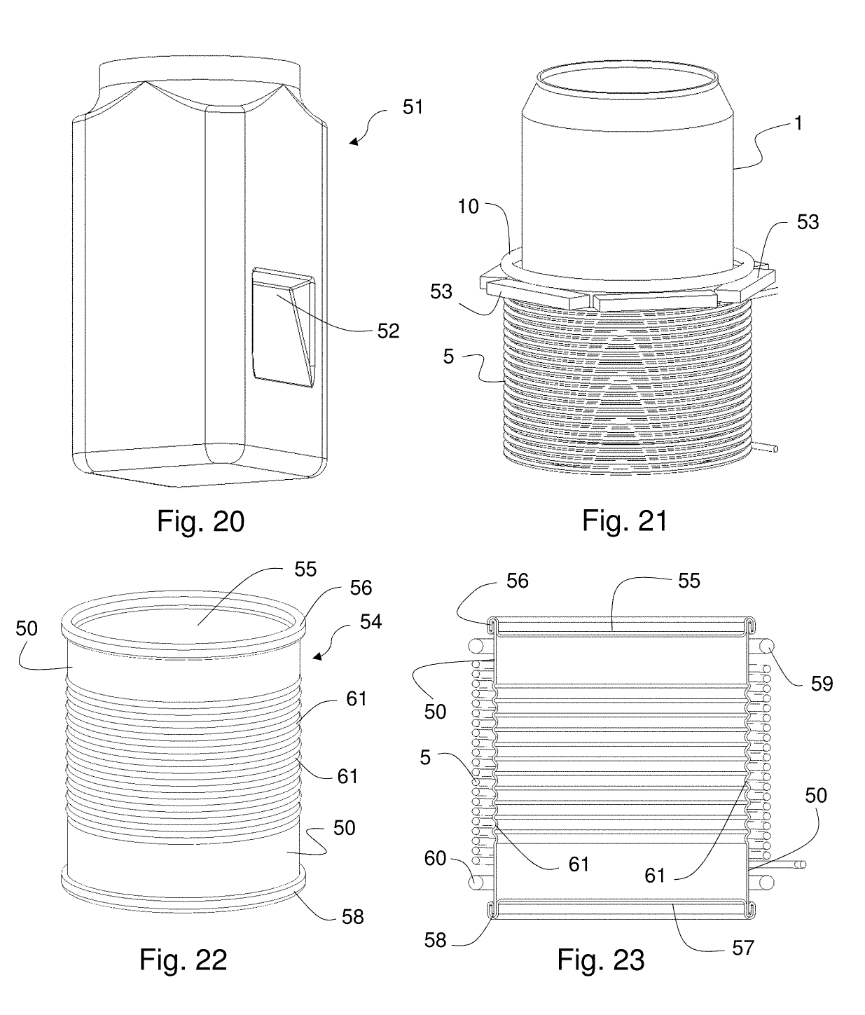

As illustrated in FIG. 20, containers of the present disclosure need not be cylindrical or round. Though previously disclosed containers include annular sidewalls extending from a bottom base to a top end, other container cross-sections are also expressly included within the scope of the present invention. Square container 51 has a generally square cross section and includes notch 52. It should be understood that containers of the present disclosure may have a wide variety of shapes and sizes and may demonstrate cross sections which are ovoid or polygonal, among many others.

FIGS. 18 and 19 illustrate another embodiment in accordance with the current disclosure. In this embodiment, slanted can 46 includes a lower sidewall 4 and an upper sidewall 3 which has larger diameter than lower sidewall. Upper sidewall 3 includes a frusto-conical slant 46 which extends from lower sidewall 4 to the point at which upper sidewall 4 has its largest diameter. A lip 48 is formed at the intersection of lower sidewall 4 and slant 47. When slanted can 46 is inserted into apparatus 9, thermometer 6 measures the temperature at a read area 49 located on slant 47.

Experimental results indicate that when slanted can 46 is subjected to induction heating, slanted can 46 behaves in a comparable manner to that which was described for notched can 14. Specifically, coil 5 heats lower sidewall 4 creating super-heated liquid 13 which flows upward within slanted can 34. When super-heated liquid 13 passes lip 48, the convective flow of super-heated liquid is disrupted creating eddies 18. Eddies 18 mix super-heated liquid 13 with cooler liquid, and the result is a temperature measured at read area 36 that is more representative of the average temperature of liquid 11 in slanted can 46. Meaningful improvement in temperature measurement may occur when the slant angle 45 is greater than 20 degrees.

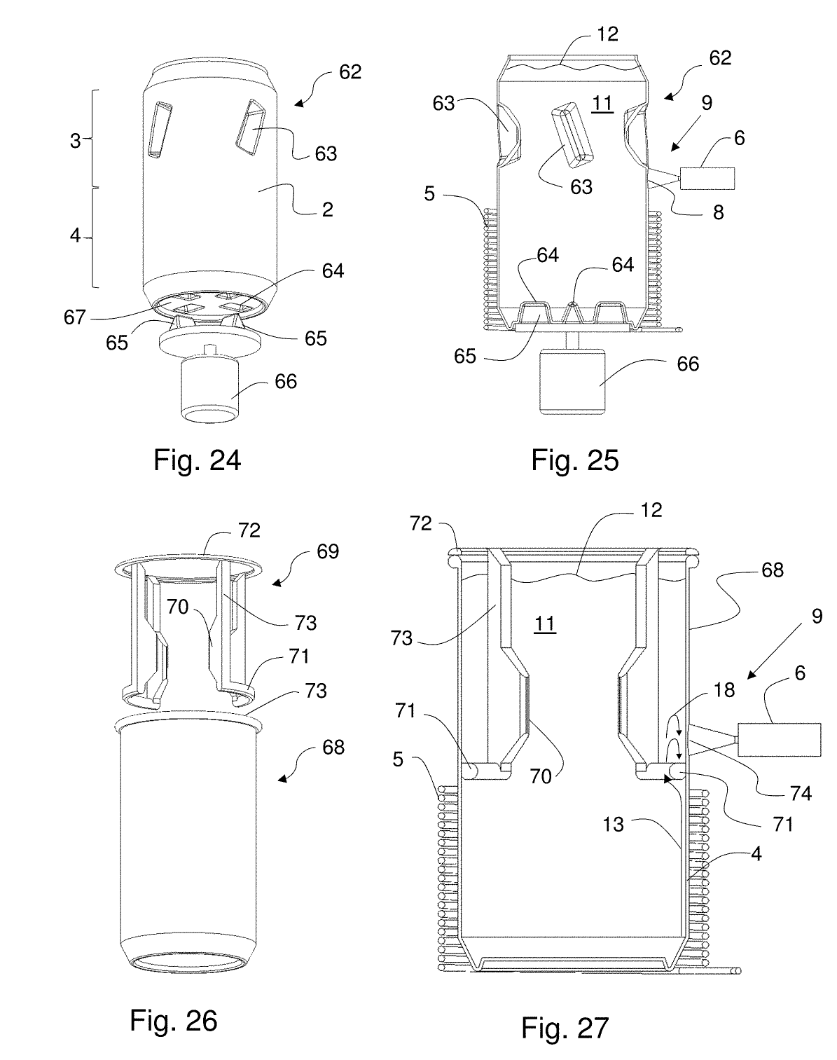

As described elsewhere in this disclosure, it is advantageous to temperature measurement if there is mixing of a container's contents as that container is being heated by induction. For example, lip 16 of FIG. 7 is operative to mix super-heated liquid 13 with other liquid 11, resulting in more accurate temperature measurement as described in FIG. 3. FIGS. 24 and 25 illustrate another embodiment of the current disclosure in which paddles are used to enhance mixing. Paddle can 62 includes a plurality of sidewall paddles 63 formed into sidewall 2, and a plurality of base paddles 64 formed into base 67. Motor 66 is provided that rotates paddle can 62 along an axis. Motor 66 is linked to drive pins 65. When paddle can 62 is inserted into an operative position within coil 5, drive pins 65 fit into base paddles 64 and provide traction for motor 66 to rotate paddle can 62. As paddle can 62 rotates, sidewall paddles 63 are operative to mix liquid 11 contained in paddle can 62, reducing radial temperature gradients and disrupting hot spots within paddle can 62. Because of this, the temperature of the liquid 11 alongside read area 8 is representative of the average temperature of the liquid within paddle can 62, thereby increasing the temperature measurement efficacy of thermometer 6.

In the prior art, a motor is sometimes provided which rotates a container during induction heating. However, in the prior art, containers have generally smooth walls or have shallow beaded walls, with the beads aligned radially with the axis of rotation. When such a smooth-walled or radially beaded container is rotated, there is relatively little friction between the wall and the liquid; what friction there is, is a product of shear forces between wall and liquid. In contrast, the sidewall paddles shown in the current disclosure create substantial friction and force between container and liquid as the container is rotated. Thus, the sidewall paddles enhance the mixing of liquid within a container when that container is rotated. Prior inventions have described systems which rotate a can or other heating container during an induction heating process. The sidewall paddles 63 may additionally function as flow features (e.g., notch, lip, slant, step, protrusion, or indentation) as described relative to the non-motorized disclosures described in relation to FIGS. 1-23 creating eddy currents within the heated contents of a container when the paddle can is not moved by a motor.

Base paddles 64 are also functional to mix liquid 11 and are particularly useful for causing the liquid at the bottom of the can to be forced upward. Such upward motion is helpful for disrupting thermal gradients which tend to form as hot liquid rises to the top of a paddle can 62. Bottom paddles 64 may serve the additional function of providing a traction surface for a rotation device. As illustrated in FIGS. 24 and 25, motor 66 is linked to drive pegs 65, and drive pegs 65 conform with bottom paddles 64. Thus, when paddle can 62 is inserted into the motor 66 equipped apparatus shown in FIG. 25, drive pegs 65 fit into bottom paddles 64, and motor 66 is mechanically linked to paddle can 62. Note that sidewall paddles 63 may be angled (i.e., not simply vertical) to create upward/downward motion of the liquid as the paddle can (or container) 62 is rotated.

Sidewall paddles 63 and bottom paddles 64 may be combined with ring and the other body contours (notch, groove, etc.) described herein to collectively and cooperatively improve the temperature measurement efficacy of an induction heating system.

In various embodiments of the present disclosure, various elements such as grooves, notches and paddles have been illustrated as being formed into a container. It should be appreciated that such elements need not be integrally formed into a container but may otherwise be provided to create the same physical result. FIGS. 26 and 27 illustrate an example of this in another embodiment in accordance with the present disclosure. In this case, smooth walled container 73 is combined with an insert 69. Insert 69 includes paddles 70 and baffles 71. When insert 69 is place in container 68, brim 72 positions insert 60 in the correct position within container 68. Legs 73 connect brim 72 to paddles 70 and baffles 71.

FIG. 27 illustrates insert 69 combined with container 73, with the combination placed in an induction heating apparatus 9. When subjected to induction heating, the combination of container 73 and insert 69 behaves in a comparable manner to that which was described for notched can 14 illustrated in FIG. 7. Specifically, coil 5 heats lower sidewall 4, creating super-heated liquid 13 which flows upward within container 73. When super-heated liquid 13 passes baffle 71, the convective flow of super-heated liquid is disrupted creating eddies 18. Eddies 18 mix super-heated liquid 13 with cooler liquid, and the result is a temperature measured at read area 8 that is more representative of the average temperature of liquid 11 in container 73.

If container 73 is rotated during the induction heating process (means of rotation not shown in FIG. 27.) then paddles 70 in FIG. 27 function similarly to the sidewall paddles illustrated in FIG. 25. Specifically, they mix liquid 11 and consequently result in improved temperature measurement relative to a system with no paddles.

Although embodiments have been described in detail with reference to the accompanying drawings for the purpose of illustration and description, it is to be understood that the disclosed processes and apparatus are not to be construed as limited thereby. It will be apparent to those of ordinary skill in the art that various modifications to the foregoing embodiments may be made without departing from the scope of the disclosure.

What is claimed is:

1. A heating apparatus for inductively heating a product held within a container, the container comprising a sidewall extending in a first direction from a bottom base to a top end and holding the product within the sidewall between the bottom base and the top end, the sidewall including a first portion configured to be heated by an induction coil, the heating apparatus comprising:
a channel configured to maintain the container in an operative position;
an at least one induction coil configured to inductively couple to at least the first portion of the sidewall of the container when the container is in the operative position within the channel, the induction coil being shorter in height than the sidewall of the container;
wherein a second portion of the container sidewall extends in the first direction beyond the height of the induction coil when the container is in the operative position; and
at least a first electrically conductive element positioned around the channel and encircling the container sidewall extending beyond the induction coil when the container is in the operative position.

2. The heating apparatus of claim 1, further comprising at least one temperature sensor positioned and configured to measure the temperature of the second portion of the container sidewall extending in the first direction from the induction coil beyond the electrically conductive element.

3. The heating apparatus of claim 1, wherein a third portion of the container sidewall extends in a second direction opposite to the first direction beyond the height of the induction coil when the container is in the operative position within the channel, and the heating apparatus further comprises a second electrically conductive element positioned around the channel and encircling the third portion of the container sidewall that extends beyond the induction coil in the second direction between the induction coil and the bottom base.

4. The heating apparatus of claim 1, wherein the at least one electrically conductive element is a closed loop encircling the channel.

5. The heating apparatus of claim 4, further comprising a switch positioned along the at least one electrically conductive closed loop, wherein when the switch is closed, the closed loop provides a continuous electrical path and when the switch is open the electrical continuity of the closed loop is broken.

6. The heating apparatus of claim 1, wherein the at least one electrically conductive element shields the second portion of the container sidewall from experiencing direct heating from the induction coil, enabling the temperature sensor to obtain a more accurate temperature reading for the product held within the container.

7. The heating apparatus of claim 1, wherein the at least one induction coil is helically wound.

8. A product container for use with an inductive heating apparatus, the heating apparatus comprising a channel for maintaining the container in an operative position, the channel extending in a first direction, an induction coil helically wound around the channel and extending between a first height and a second height in the first direction, and a temperature sensor configured to measure the temperature of the container at a third height that is not between the first height and the second height, the container comprising:
a bottom base;
a sidewall extending from the bottom base to a top end, the sidewall comprising a first portion and a second portion;
wherein the first portion of the sidewall being configured to be positioned between the first height and the second height inside the channel when the container is in the operative position, the first portion being configured to inductively couple with the induction coil;
wherein the second portion of the sidewall being configured to extend in the first direction beyond the area between the first height and the second height when the container is in the operative position;
wherein the container is configured to enclose the product inside of the sidewall between the bottom base and the top end;
wherein a length of the sidewall in the first direction is greater than the distance between the first height and the second height;
an at least one internal flow feature extending from the sidewall to create eddy currents as the product is indirectly heated by the induction coil's coupling to the first portion of the sidewall; and
an at least one read area on an outside surface of the second portion of the sidewall, the read area being positioned at the third height and configured to provide a surface for the temperature sensor to obtain a temperature measurement.

9. The container of claim 8, wherein at least a portion of the flow feature is positioned between the first height and the second height when the container is in the operative position.

10. The container of claim 8, wherein at least a portion of the flow feature is positioned outside of the first height and the second height when the container is in the operative position.

11. The container of claim 8, wherein the at least one read area is positioned on an outside surface of the flow feature.

12. The container of claim 8, wherein the flow feature is a groove extending radially inward from the sidewall of the container.

13. The container of claim 8, wherein the flow feature is a step or slant and the radius of the sidewall at a point within the flow feature is greater than the radius of the first portion of the sidewall.

14. The container of claim 8, wherein the flow feature is a notch or indentation extending inward from the sidewall of the container.

15. The container of claim 8, wherein the flow feature is a protrusion extending outward from the sidewall of the container.

16. The container of claim 8, wherein the heating apparatus further comprises a first electrically conductive element positioned around the channel and encircling the container sidewall above the second height and shielding the container sidewall above the second height from experiencing direct heating from the induction coil, and the read area is positioned on the opposite side of the conductive element from the induction coil.

17. The container of claim 8, wherein the heating apparatus further comprises a first electrically conductive element positioned around the channel and encircling the container sidewall above the second height and shielding the container sidewall above the second height from experiencing direct heating from the induction coil, and the flow feature is positioned on the opposite side of the conductive element from the induction coil.

18. The container of claim 8, wherein the heating apparatus further comprises a motor configured to rotate or otherwise create motion in an apparatus engagement feature, and the container further comprising a container engagement feature configured to engage the apparatus engagement feature, and wherein the engagement between the container engagement feature and the apparatus engagement feature transfers the motion from the motor to the container.

19. A motorized heating apparatus for inductively heating and mechanically mixing a product held within a paddle container, the paddle container comprising a sidewall extending in a first direction from a bottom base to a top end and holding the product within the sidewall between the bottom base and the top end, the sidewall being configured to be heated by an induction coil, the container including a plurality of paddles extending inward from the sidewall or the bottom base of the container to create eddy currents as the product is indirectly heated by the induction coil's coupling to the sidewall, the motorized heating apparatus comprising:
a channel configured to maintain the paddle container in an operative position;
an at least one induction coil configured to inductively couple to at least a portion of the sidewall of the paddle container when the paddle container is in the operative position;
a motor connected to and configured to rotate or otherwise transfer motion to the paddle container, causing the paddles of the paddle container to improve mixing of the contents of the paddle container; and
at least one temperature sensor positioned and configured to measure the temperature of the paddle container sidewall above the induction coil.

20. The motorized heating apparatus of claim 19, further comprising a first electrically conductive element positioned around the channel, above the induction coil and below the at least one temperature sensor, encircling the paddle container sidewall when the paddle container is in the operative position.
